(19) United States
(12) Patent Application Publication
(10) Pub. No.: US 2022/0309843 A1
(43) Pub. Date: Sep. 29, 2022

(54) PROGRAM UPDATE MANAGEMENT SYSTEM, MOVING BODY FAULT DIAGNOSIS DEVICE, AND PROGRAM UPDATE MANAGEMENT METHOD

(71) Applicant: HONDA MOTOR CO., LTD., Tokyo (JP)

(72) Inventors: Tomoaki Taki, Tokyo (JP); Takeshi Kanda, Tokyo (JP)

(21) Appl. No.: 17/677,539

(22) Filed: Feb. 22, 2022

(30) Foreign Application Priority Data
Mar. 26, 2021 (JP) 2021-052604

(51) Int. Cl. G07C 5/08; G07C 5/00; G06F 8/65; G06F 8/71

(52) U.S. Cl. CPC G07C 5/0808; G07C 5/008; G06F 8/65; G06F 8/71

(57) ABSTRACT

A program update management system includes an acquisition unit configured to acquire an update program from an update history management device that manages an update history of a program, a writing unit configured to write the update program into an ECU of the moving body, and a communication control unit configured to control a communication unit that transmits writing progress information about progress of writing of the update program to the update history management device of the program, in which the program is installed into the moving body control device through the moving body fault diagnosis device, and the output control unit controls the output unit so that a predetermined output is provided until the moving body fault diagnosis device transmits the information about the progress to the update history management device.

### INCORPORATION BY REFERENCE

The present application claims priority under 35 U.S.C. § 119 to Japanese Patent Application No. 2021-052604 filed on Mar. 26, 2021. The content of the application is incorporated herein by reference in its entirety.

### BACKGROUND OF THE INVENTION

### Field of the Invention

The present invention relates to a program update management system that manages program updates for an electronic control unit mounted on a moving body, a moving body fault diagnosis device, and a program update management method.

### Description of the Related Art

In recent years, a movement to make vehicles “connected” is progressing in which a moving body or a vehicle is connected to a network utilizing a wireless technology. In such “connected” vehicles, comfortable operation such as autonomous driving is expected in the future, whereas a security risk in which a vehicle is attacked through a network is increasing. Many electronic control units are used for a current vehicle, and software for controlling the electronic control units require updates involving addition or correction of functions. Since the update management for the software is directly related to the user's safety, the update management is to be subjected to the regulation by the laws based on the international standards. In the regulation, thorough update management for the software is required, and the history management is required for both cases of when the software is updated through a wired connection and when the software is updated through a wireless connection.

Japanese Patent Laid-Open No. 2020-96321 discloses a technique for determining whether an update device to be connected to a vehicle is authenticated even outside the network range, in order to prevent rewriting of a program by ill-intentioned third parties. However, when the authenticated update device is wiredly connected to the vehicle and performs update work, a cable may inadvertently escape to prevent a program from being properly updated or even when the program has been properly updated, such program update may be unable to be confirmed. Therefore, a dealer or a user of the vehicle that performs the update work is less likely to recognize such an accident.

The present invention is made in the light of the above-described background, and has an object to provide a program update management system that notifies that update processing work is being performed in the middle of the processing when a program is updated through a wired connection for an electronic control unit mounted on a moving body, a moving body fault diagnosis device, and a program update management method.

### SUMMARY OF THE INVENTION

An inventive aspect to achieve the object described above provides a program update management system that includes a moving body fault diagnosis device that updates and manages a program for controlling a moving body, and a moving body control device that controls an operation of the moving body, the moving body control device being provided in the moving body, the program update management system including an acquisition unit configured to acquire an update program from an update history management device that manages an update history about update of the program, a writing unit configured to write the update program into an individual ECU for controlling a device included in the moving body, and a communication control unit configured to control a communication unit that transmits writing progress information about progress of writing of the update program to the update history management device of the program, wherein the moving body includes an output unit from which information is to be output, the program is installed into the moving body control device through the moving body fault diagnosis device, the moving body control device includes an output control unit configured to control the output unit, and the individual ECU configured to control the device included in the moving body, and the output control unit controls the output unit so that a predetermined output is provided until the moving body fault diagnosis device transmits the information about the progress to the update history management device.

The above-described program update management system may have a configuration in which the writing progress information includes writing completion information indicating that the writing of the update program into the individual ECU has been completed.

The above-described program update management system may have a configuration in which the writing progress information includes activation information indicating that the written update program has been made available to the moving body.

The above-described program update management system may have a configuration in which there is further provided a completion notification information acquisition unit configured to acquire completion notification information indicating the update based on the update program has been completed, the update program being acquired from the moving body fault diagnosis device, and furthermore information about the completion has been reported to the update history management device, and the output control unit stops the predetermined output based on the completion notification information.

The above-described program update management system may have a configuration in which the moving body includes no communication device configured to perform cellular communication.

The above-described program update management system may have a configuration in which the communication control unit and the acquisition unit are provided in the moving body fault diagnosis device, the moving body control device and the moving body fault diagnosis device are connected to each other through wired communication means, and the wired communication means is used to acquire the update program, write the update program, and transmit the writing progress information to the update history management device.

The above-described program update management system may have a configuration in which when a first update history which is an update history of the program installed into the moving body control device matches a predetermined program configuration and it is determined that the output unit is providing the predetermined output, the moving body fault diagnosis device instructs the output control unit to stop the predetermined output.

Another inventive aspect to achieve the object described above provides a moving body fault diagnosis device that updates and manages a program for controlling a moving body having an output unit configured to output information, the moving body fault diagnosis device including a writing unit configured to write an update program of the program into an ECU for controlling the moving body, a communication control unit configured to control a communication unit that transmits information about writing progress of the writing unit to an update history management device that manages a update history of the program, and a writing unit configured to write a control signal for controlling so that the output unit included in a moving body control device provides a predetermined output until the information about the progress is transmitted to the update history management device.

Another inventive aspect to achieve the object described above provides a program update management method that updates and manages a program for controlling a moving body having an output unit configured to output information, the method including a writing step of writing an update program of the program into an ECU that performs control of the moving body, a communication control step of transmitting writing progress information about writing progress of the writing step to an update history management device that manages an update history of the program, and an output control step of controlling the output unit so that a predetermined output is provided until the information about the progress is transmitted to the update history management device.

When any errors such as coming-off or disconnection of a cable occur in the middle of the program update processing work of an electronic control unit mounted on the moving body, an update operator or a manager of the moving body can easily recognize the errors. This makes it possible to ensure that the program update history is properly managed.

### BRIEF DESCRIPTION OF THE DRAWINGS

FIG. 1 is a diagram illustrating program update in a moving body;

FIG. 2 is a configuration diagram of a program update management system;

FIG. 3 is a functional block diagram illustrating a moving body and a moving body fault diagnosis device;

FIG. 4 is a flowchart of program update management according to a first embodiment; and

FIG. 5 is a flowchart of the program update management according to the first embodiment.

### DETAILED DESCRIPTION OF THE PREFERRED EMBODIMENTS

Hereinafter, embodiments will be described in detail with reference to the drawings. However, the detailed description more than necessary may be omitted. For example, detailed description of well-known matters and redundant description on substantially the same configuration may be omitted. This is to avoid an unnecessary redundancy in the following description and to facilitate understanding by those skilled in the art.

Note that the accompanying drawings and the following description are provided to enable those skilled in the art to fully understand the present disclosure and are not intended to limit subject matters of claims.

### 1-1. Configurations of Program Update Management System According to First Embodiment

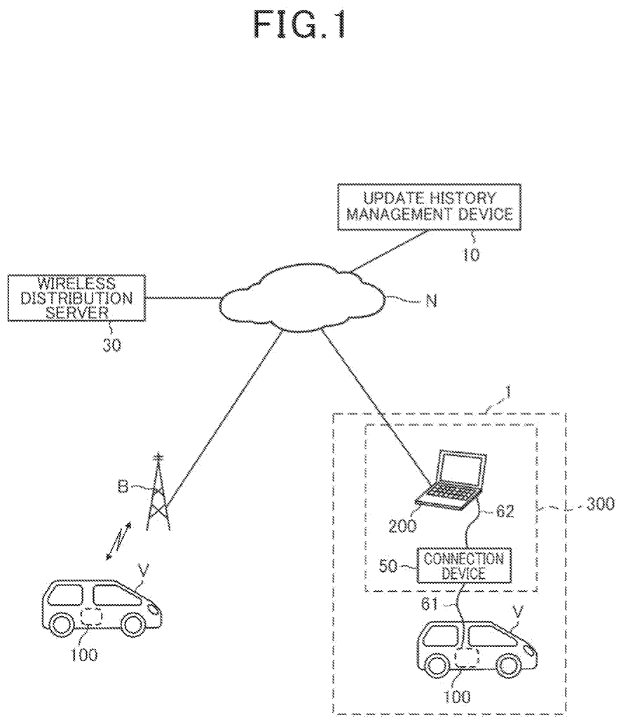

FIG. 1 is a diagram illustrating program update in a moving body (vehicle) V. In the case where a device of a moving body V supports program update through wireless communication, that is, in the case where software can be updated through over the air (OTA), an update program is distributed from a wireless distribution server 30 (server computer) to the moving body V through a network N and a base station B, and a program is updated. At this time, an update history of the program is managed by an update history management device 10 in association with a vehicle identification number of the moving body V. In a dealer or a maintenance shop, the program is updated through a wired connection. The update history management device 10 is comprised of a computer, and transmits the update program to a program update management system 1. Of course, also in this case, the update history of the program is managed by the update history management device 10. The program update management system 1 includes the moving body V having a moving body control device 100 configured to control the moving body V, and a moving body fault diagnosis device 300 configured to be connected to the moving body control device 100 to diagnose a fault in the moving body and update the program, and the moving body fault diagnosis device 300 includes a maintenance personal computer (PC) 200, and a connection device 50. The maintenance PC 200 and the connection device 50 are connected to each other through wired connection means, specifically through a cable 62, and the connection device 50 and the moving body control device 100 are connected to each other through the wired connection means, specifically through a cable 61. Specifically, the cable used for the wired connection may be, for example, a USB cable. Of course, the cable may include an OBD connector generally used when a vehicle which is the moving body and on-board diagnostics (OBD) are connected to each other.

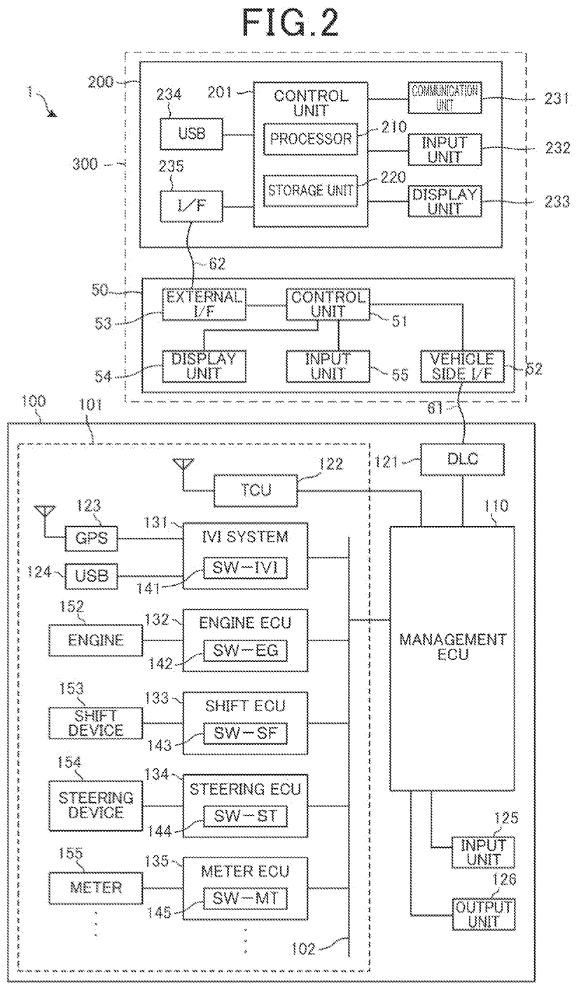

FIG. 2 is a configuration diagram of the program update management system 1 according to a first embodiment. The program update management system 1 includes the moving body control device 100 of the moving body V and the moving body fault diagnosis device 300. The moving body fault diagnosis device 300 includes the maintenance PC 200 and the connection device 50. The maintenance PC 200 is an information processing device including a communication unit 231 (a transmitter and a receiver) configured to communicate with the network N, an input unit 232 to which information is to be input, a display unit 233 (display) on which information is to be displayed using an image or the like, a control unit 201 configured to control the entire maintenance PC 200, a universal serial bus (USB) connector 234 which is a connection unit for transmitting and receiving information to and from the outside, and an interface 235 for transmitting and receiving information to and from the connection device 50. The connection device 50 is a computer that is provided between the moving body fault diagnosis device 300 and the moving body control device 100, and includes a control unit 51 (processor) configured to perform control, an input unit 55 to which information is to be input, a display unit 54 (display) from which information is to be output, an external interface 53 which is an interface for transmitting and receiving information to and from the maintenance PC 200, and a vehicle side interface 52 for transmitting and receiving information to and from the moving body control device 100. The connection device 50 may be a vehicle control interface (VCI).

The moving body control device 100 includes a data link coupler (DLC) 121 which is a connection connector to be connected with the connection device 50 through the cable 61, an on-board device 101, a management ECU 110 configured to control individual electronic control units (ECUs) which are control devices configured to control respective devices included in the moving body V, an input unit 125 to which information is to be input, and an output unit 126 from which information is to be output. The input unit 125 may be a touch panel in an on-board in-vehicle infotainment (IVI) system. The output unit 126 may be an image display device included in the IVI or an image display device provided in a meter portion. The output unit 126 may be provided in an instrument panel of a driver's seat, for example. Specifically, the output unit 126 is configured as a so-called multi information display (MID) incorporated in a meter panel. The output unit 126 may be a speaker configured to output voice. Alternatively, the output unit 126 may be a hazard lamp.

The on-board device 101 includes a plurality of devices mounted on a vehicle, and electronic control units (ECUs) configured to control the respective devices. The on-board device 101 may include, for example, a telematics control unit (TCU) 122 for performing wireless communication as a device. Additionally, the on-board device 101 may include an IVI system 131, an engine ECU 132 configured to control an engine 152, a shift ECU 133 configured to control a shift device 153, a steering ECU 134 configured to control a steering device 154, and a meter ECU 135 configured to control a meter 155. Each ECU is connected to the management ECU 110 through a bus 102, to transmit or receive information including a program (software) to or from the management ECU 110.

The IVI system 131 implements its function by executing software SW-IVI 141, the engine ECU 132 implements its function by executing software SW-EG 142, the shift ECU 133 implements its function by executing software SW-SF 143, the steering ECU 134 implements its function by executing software SW-ST 144, and the meter ECU 135 implements its function by executing software SW-MT 145. In each software, a program is updated by the program update management system 1 through the wired connection using the cable 61.

The ECU is a computer that has a processor such as a central processing unit (CPU), and a memory such as a read only memory (ROM) into which a program is written, a random access memory (RAM) for temporarily storing data. Specifically, the above-described control is executed by causing the ECU which is a computer to execute a program received from the update history management device 10 through the maintenance PC 200. Instead of or in addition to the above-described ECUs, all or some of the above-described ECUs may be each configured of hardware including one or more electronic circuit components.

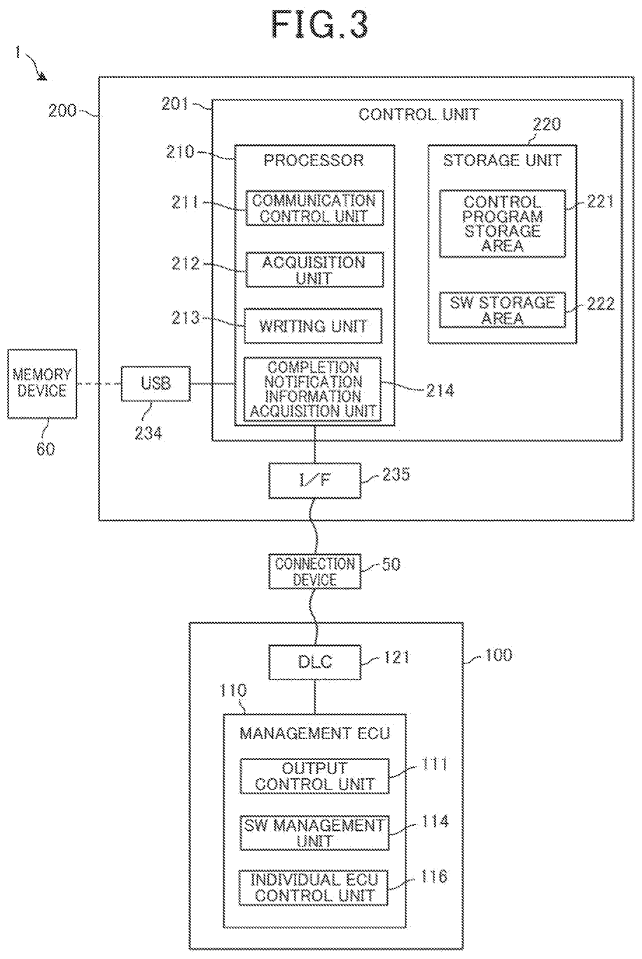

FIG. 3 is a functional block diagram illustrating the moving body V and the maintenance PC 200. The maintenance PC 200 includes the control unit 201, a USB connector 234, and the interface 235. The control unit 201 includes a storage unit 220 (memory) configured to store information, and a processor 210 configured to process information to be stored in the storage unit 220. The processor 210 may be a so-called central processing unit (CPU). The storage unit 220 includes a control program storage area 221 configured to store programs for controlling the maintenance PC 200 and the connection device 50, and a SW storage area configured to store an update program for the ECU. The storage unit 220 may be a hard disk drive (HDD) or a solid state drive (SSD). Although FIG. 3 illustrates an aspect in which an update program is stored in the storage unit 220, the update program may be directly read from a memory device 60 through the USB connector 234 without being held in the maintenance PC 200. The processor 210 executes a control program stored in the control program storage area 221 of the storage unit 220, thereby implementing functions of a communication control unit 211 configured to control the communication unit 231 that transmits and receives information to and from the outside, an acquisition unit 212 configured to acquire an update program from the update history management device 10 (see FIG. 1), a writing unit 213 configured to write the update program into the ECU of the moving body control device 100 through the connection device 50, and a completion notification information acquisition unit 214 configured to acquire completion notification information indicating that update based on the update program has been completed and furthermore the information about the completion has been reported to the update history management device 10.

The update program is transmitted to the DLC 121 of the moving body control device 100 through the interface 235 (connector) and the connection device 50 that are connected to each other through the wired cable, and the management ECU 110 transmits the update program to the individual ECUs configured control the on-board device 101. The management ECU 110 includes a processor and a memory, and causes the processor to implement functions of an output control unit 111 configured to control the output unit 126, a SW management unit 114 configured to manage an update program, and an individual ECU control unit 116 configured to control each ECU.

Specifically, while the program update management system 1 is performing program update processing, the output control unit 111 controls so that the output unit 126 provides an output indicating that the processing is under execution. The output is, for example, an image indicating the processing is under execution, and the image may be continuously displayed in the image display device. As another example, the output may be an alarm sound emitted from the output unit 126, or may cause the hazard lamp to flash for a predetermined period time.

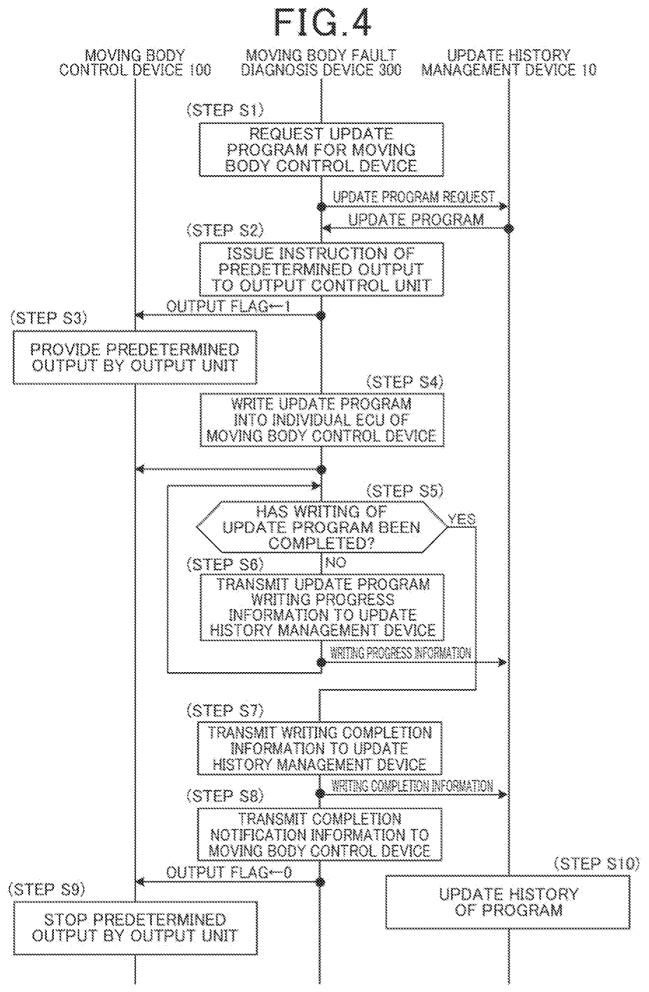

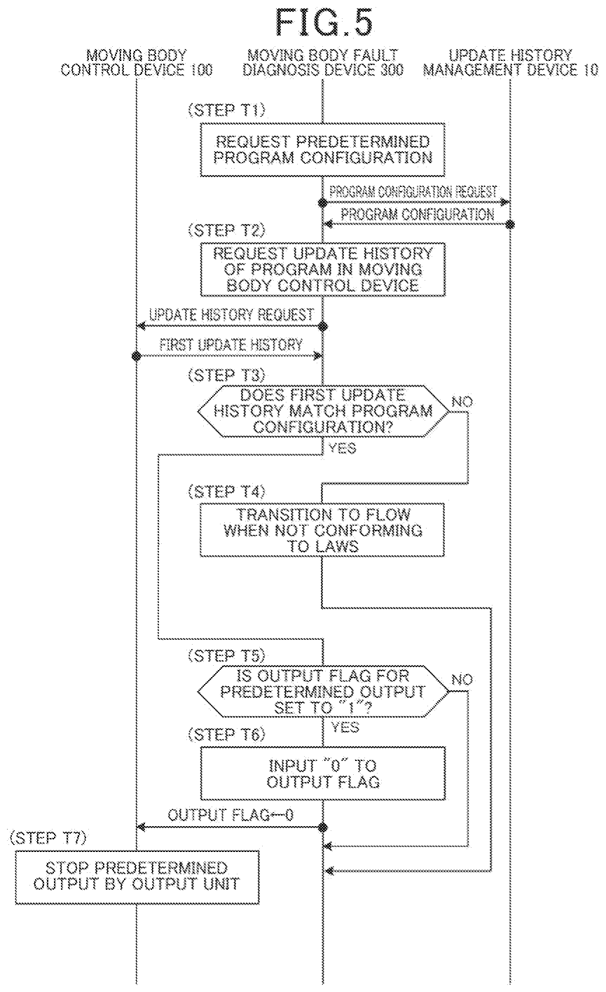

Note that the update history management device 10 may be a server configured to manage an update program. It is desirable that the update history management device 10 manages a version of a program installed into each ECU of the moving body control device 100, and determines whether the program is brought into a state conforming to the laws. Operations of the program update management system 1 will be described in detail with reference to FIGS. 4 and 5. The update history management device 10 and the maintenance PC 200 may be constantly connected to each other through the network N.

### 1-2. Operations of Program Update Management System

FIG. 4 is a flowchart of program update management by the program update management system 1 according to the first embodiment.

First, the moving body fault diagnosis device 300 requests, to the update history management device 10, an update program for the moving body control device 100, specifically, an update program for an individual ECU configured to control each device mounted on the moving body V (step S1). The update history management device 10 transmits the update program to the moving body fault diagnosis device 300 in response to the request. The moving body fault diagnosis device 300 instructs the output control unit 111 of the moving body control device 100 to provide a predetermined output. Specifically, the writing unit 213 inputs “1” to an output flag (step S2). The moving body control device 100 controls so that the output unit 126 provides a predetermined output in response to the output flag being set to “1” (step S3). The moving body fault diagnosis device 300 writes the update program into the individual ECU of the moving body control device 100 (step S4). Next, the moving body fault diagnosis device 300 determines whether writing of the update program has been completed (step S5). When the writing of the update program has not been completed (step S5: NO), the moving body fault diagnosis device 300 transmits, to the update history management device 10, writing progress information which is information about a writing progress status of the update program (step S7), and the processing returns to step S5. When the writing of the update program has been completed (step S5: YES), the moving body fault diagnosis device 300 transmits, to the update history management device 10, writing completion information indicating that the writing of the update program has been completed. The update history management device 10 receives the writing completion information and updates a program update history associated with the vehicle identification number of the moving body V (step S10). In addition, the moving body fault diagnosis device 300 transmits, to the moving body control device 100, completion notification information indicating that the program update has been completed. That is, the completion notification information acquisition unit 214 acquires the completion notification information, and transmits the completion notification information to the moving body control device 100. Specifically, the writing unit 213 inputs “0” to a output flag (step S8). The output control unit 111 of the moving body control device 100 controls the output unit 126 so that a predetermined output is stopped, in response to the output flag being set to “0” (step S9). Specifically, the output control unit 111 erases the image indicating that the processing is under execution, the image being displayed on an image display unit (display) which is the output unit 126.

FIG. 5 illustrates operations of the program update management system 1 in the case where the output unit 126 provides the output indicating that the processing is under execution even after an update operator of the moving body fault diagnosis device 300 or a manager of the moving body V considers that the program update has been completed.

First, the moving body fault diagnosis device 300 requests a predetermined program configuration to the update history management device 10 (step T1). The predetermined program configuration includes information about a combination of update programs conforming to the laws. The update history management device 10 transmits information about the program configuration suitable for the moving body V at that time to the moving body fault diagnosis device 300 in response to the request. Specifically, the update history management device 10 transmits, to the moving body fault diagnosis device 300, the information about the program configuration associated with the vehicle identification number of the moving body V. Next, the moving body fault diagnosis device 300 requests, to the moving body control device 100, an update history of a program for controlling the ECU in the moving body control device 100. Specifically, the moving body fault diagnosis device 300 requests, to the moving body control device 100, version information on an update program in the individual ECU (step T2). The moving body control device 100 transmits, to the moving body fault diagnosis device 300, a first update history which is an update history at that time, in response to the update history request. The moving body fault diagnosis device 300 compares the first update history with the program configuration transmitted from the update history management device 10, and determines whether the first update history and the program configuration match each other. Specifically, the moving body fault diagnosis device 300 determines whether a combination of versions of the updated programs for the individual ECUs matches the program configuration conforming to the laws, the program configuration being transmitted from the update history management device 10 (step T3). When the first update history and the program configuration match each other (step T3: YES), the moving body fault diagnosis device 300 determines whether the output unit 126 provides an output indicating the processing is under execution. Specifically, the moving body fault diagnosis device 300 determines whether the output flag is set to “1” (step T5). When the output flag is set to “1” (step T5: YES), the writing unit 213 inputs “0” to an output flag. Specifically, the moving body fault diagnosis device 300 instructs the output control unit 111 to stop the predetermined output in the output unit 126 (step T6). The moving body control device 100 controls the output control unit 111 so that the output unit 126 stops a predetermined output, in response to the output flag being set to “0.” Specifically, the moving body control device 100 erases the image indicating that the processing is under execution, the image being displayed on the image display unit which is the output unit 126. When the first update history and the program configuration do not match each other (step T3: NO), the processing transitions to operations when not conforming to the laws (step T4). Although a flow when not conforming to the laws is not described herein, it is desirable that when not conforming to the laws, the moving body fault diagnosis device 300 updates a control program in the individual ECU so that the moving body control device 100 achieves a combination of the update programs conforming to the laws.

### 2-1. Configuration of Moving Body Fault Diagnosis Device According to Second Embodiment

A moving body fault diagnosis device 300 according to a second embodiment includes a writing unit 213 (see FIG. 3) configured to write an update program of a program into an ECU that performs control of a moving body V, a communication control unit 211 configured to control a communication unit 231 that transmits information about the writing progress of the writing unit 213 to the update history management device 10 (see FIG. 1) that manages an update history of the program, and an output control unit 111 configured to control an output unit 126 of a moving body control device 100 so that a predetermined output is provided until the information about the progress is transmitted to the update history management device 10.

A configuration of the moving body fault diagnosis device 300 according to the second embodiment is similar to the configuration of the moving body fault diagnosis device 300 included in the program update management system 1 according to the first embodiment, and hence detailed description is omitted.

### 2-2. Operations of Moving Body Fault Diagnosis Device

Operations of the moving body fault diagnosis device 300 according to the second embodiment are similar to the operations of the moving body fault diagnosis device 300 included in the program update management system 1 according to the first embodiment (see FIGS. 4 and 5), and hence detailed description is omitted.

### 3. Program Update Management Method According to Third Embodiment

A program update management method according to a third embodiment is a program update management method that updates and manages a program for controlling a moving body having an output unit configured to output information, the method including a writing step of writing an update program of the program into an ECU that performs control of the moving body, a communication control step of transmitting writing progress information about writing progress of the writing step to an update history management device that manages an update history of the program, and an output control step of controlling the output unit so that a predetermined output is provided until the information about the progress is transmitted to the update history management device.

### 4. Other Embodiments

In the above-described embodiments, an example has been described in which installation of the update program on the individual ECU is performed by the writing unit 213 of the maintenance PC 200, but the installation may be performed by the management ECU 110. At this time, it is also conceivable that an operation of acquiring the update program from the update history management device 10 is performed by the moving body control device 100.

In the above-described embodiments, an aspect has been described in which the moving body fault diagnosis device 300 newly writes the update program into the individual ECU, but the update program may be pre-installed into the individual ECU to be made available to the moving body V according to an instruction from the moving body fault diagnosis device 300. At this time, it is also conceivable that activation information indicating that each update program has been made available is transmitted to the update history management device 10. Specifically, in the case where the moving body control device 100 transmits, to the update history management device 10, the writing progress information about the progress of writing of the update program, the writing progress information includes the activation information indicating that the written update program has been made available to the moving body V.

In addition, in the above-described embodiments, an aspect has been described in which an update program is acquired from the update history management device 10, but the update program may be distributed by the memory device 60 or the like so that the update history management device 10 performs only the management of the update history of the program. In addition, an aspect has been described in which an update program is stored in the SW storage area 222, but it is also conceivable that the update program is not stored in the storage unit 220 to increase the security level.

### 5. Configurations Supported by Above-described Embodiments

The above-described embodiments support the following configurations.

(Configuration 1) A program update management system 1 that includes a moving body fault diagnosis device 300 that updates and manages a program for controlling a moving body V, and a moving body control device 100 that controls an operation of the moving body V, the moving body control device 100 being provided in the moving body V, the program update management system 1 including an acquisition unit 212 configured to acquire an update program from an update history management device 10 that manages an update history about update of the program, a writing unit 213 configured to write the update program into an individual ECU for controlling a device included in the moving body V, and a communication control unit 21 configured to control a communication unit 231 that transmits writing progress information about progress of writing of the update program to the update history management device 10 of the program, wherein the moving body V includes an output unit 126 from which information is to be output, the program is installed into the moving body control device 100 through the moving body fault diagnosis device 300, the moving body control device 100 includes an output control unit 111 configured to control the output unit 126, and the individual ECU configured to control the device included in the moving body V, and the output control unit 111 controls the output unit 126 so that a predetermined output is provided until the moving body fault diagnosis device 300 transmits the information about the progress to the update history management device 10.

According to the program update management system of configuration 1, when any troubles such as coming-off or disconnection of a cable occur during the update processing of the program used for control of the moving body, an update operator or a manager of the moving body can easily recognize the progress of the update processing. This produces an advantageous effect that the program history can be properly managed.

(Configuration 2) The program update management system according to configuration 1 wherein the writing progress information includes writing completion information indicating that the writing of the update program into the individual ECU has been completed.

According to the program update management system of configuration 2, the update operator or the manager of the moving body can easily recognize that the program update has been completed, whereby the update operator or the manager of the moving body can confirm that the program has been properly updated.

(Configuration 3) The program update management system according to configuration 1 or 2 wherein the writing progress information includes activation information indicating that the written update program has been made available to the moving body V.

According to the program update management system of configuration 3, the update program is preliminarily stored in the moving body control device that controls the moving body in the unavailable state, and therefore this makes it possible to manage which program is available for each moving body even when the update program is activated to be available when the conditions are satisfied.

(Configuration 4) The program update management system according to any one of configurations 1 to 3, wherein there is further provided a completion notification information acquisition unit 214 configured to acquire completion notification information indicating the update based on the update program has been completed, the update program being acquired from the moving body fault diagnosis device 300, and furthermore information about the completion has been reported to the update history management device 10, and the output control unit 111 stops the predetermined output based on the completion notification information.

According to the program update management system of configuration 4, the fact that the program update has been completed can be reported to the update history management device, whereby the program can be properly updated. The output indicating the update processing is under execution is stopped upon receipt of the report that the program update has been completed, whereby the fact that the program update has been completed can be reported to the update worker or the manager of the moving body.

(Configuration 5) The program update management system according to any one of configurations 1 to 4, wherein the moving body V includes no communication device configured to perform cellular communication.

According to the program update management system of configuration 5, the update history of the program can be properly managed even for the moving body that cannot update the program by cellular communication.

(Configuration 6) The program update management system according to any one of configurations 1 to 5, wherein the communication control unit 211 and the acquisition unit 212 are provided in the moving body fault diagnosis device 300, the moving body control device 100 and the moving body fault diagnosis device 300 are connected to each other through wired communication means, and the wired communication means is used to acquire the update program, write the update program, and transmit the writing progress information to the update history management device 10.

According to the program update management system of configuration 6, the program update and the management of the update history can be performed by the wired communication means, whereby the security level can be increased. The writing progress information can be transmitted and received securely, whereby the update history of the program can be properly managed.

(Configuration 7) The program update management system according to any one of configurations 1 to 6, wherein when a first update history which is an update history of the program installed into the moving body control device 100 matches a predetermined program configuration and it is determined that the output unit 126 is providing the predetermined output, the moving body fault diagnosis device 300 instructs the output control unit 111 to stop the predetermined output.

According to the program update management system of configuration 7, the fact that the update processing of the program has been completed can be reported to the update operator or the manager of the moving body, after the update operator or the manager of the moving body confirms that the updated program has a program configuration conforming to the laws.

(Configuration 8) A moving body fault diagnosis device 300 that updates and manages a program for controlling a moving body V having an output unit 126 configured to output information, the moving body fault diagnosis device 300 including a writing unit 213 configured to write an update program of the program into an ECU for controlling the moving body V, a communication control unit 211 configured to control a communication unit 231 that transmits information about writing progress of the writing unit 213 to an update history management device 10 that manages a update history of the program, and a writing unit 213 configured to write a control signal for controlling so that the output unit 126 included in a moving body control device 100 provides a predetermined output until the information about the progress is transmitted to the update history management device 10.

According to the program update management system of configuration 8, when any troubles such as coming-off or disconnection of a cable occur during the update processing of the program used for control of the moving body, an update operator or a manager of the moving body can easily recognize the progress of the update processing. This produces an advantageous effect that the program history can be properly managed.

(Configuration 9) A program update management method that updates and manages a program for controlling a moving body V having an output unit 126 configured to output information, the method including a writing step of writing an update program of the program into an ECU that performs control of the moving body V, a communication control step of transmitting writing progress information about writing progress of the writing step to an update history management device 10 that manages an update history of the program, and an output control step of controlling the output unit 126 so that a predetermined output is provided until the information about the progress is transmitted to the update history management device 10.

According to the program update management system of configuration 9, when any troubles such as coming-off or disconnection of a cable occur during the update processing of the program used for control of the moving body, an update operator or a manager of the moving body can easily recognize the progress of the update processing. This produces an advantageous effect that the program history can be properly managed.

The embodiments have been described as exemplifications of the techniques disclosed in the present application. However, the techniques in the present disclosure are not limited thereto, and are also applicable to embodiments in which modifications, replacements, additions, omissions and the like are made. Additionally, the constituent elements described in the above-described embodiments can be combined to provide a new embodiment.

For example, step units of control operations illustrated in FIGS. 4 and 5 are classified according to main processing contents to facilitate the understanding of operation of each unit of the program update management system 1 and the present invention is never limited by the way how to divide the processing units or the names. The step units of operation may be divided into still more step units according to the processing contents. The step units of operation may be divided such that one step unit includes still more processes. The order of steps may be switched around as appropriate without departing from the sprit and scope of the present invention.

### REFERENCE SIGNS LIST

1 Program update management system
10 Update history management device
30 Wireless distribution server
50 Connection device
51 Control unit
52 Vehicle side interface
53 External interface
54 Display unit
55 Input unit
60 Memory device
61 Cable
62 Cable
100 Moving body control device
101 On-board device
102 Bus
110 Management ECU
111 Output control unit
114 SW management unit
116 Individual ECU control unit
121 DLC
122 TCU
123 GPS unit
124 USB connector
125 Input unit
126 Output unit
131 IVI system
132 Engine ECU
133 Shift ECU
134 Steering ECU
135 Meter ECU
141 SW-IVI
142 SW-EG
143 SW-SF
144 SW-ST
145 SW-MT
152 Engine
153 Shift device
154 Steering device
155 Meter
200 Maintenance PC
201 Control unit
210 Processor
211 Communication control unit
212 Acquisition unit
213 Writing unit
214 Completion notification information acquisition unit
220 Storage unit
221 Control program storage area
222 SW storage area
231 Communication unit
232 Input unit
233 Display unit
234 USB connector
235 Interface
300 Moving body fault diagnosis device
B Base station
V Moving body (vehicle)
N Communication network

What is claimed is:

1. A program update management system, comprising:
a moving body fault diagnosis device that includes a fault diagnosis device processor, in which the fault diagnosis device processor updates and manages a program for controlling a moving body; and
a moving body control device that includes a control device processor, in which the control device processor controls an operation of the moving body,
wherein the fault diagnosis device processor is configured to:
acquire an update program from an update history management device that manages an update history about update of the program;
write the update program into an individual ECU for controlling a device included in the moving body; and
transmit writing progress information about progress of the writing of the update program to the update history management device of the program,
wherein the moving body includes a display from which information is to be output,
wherein the program is installed into the moving body control device through the moving body fault diagnosis device,
wherein the moving body control device is configured to
control the display,
wherein the moving body includes a plurality of ECUs each provided with an ECU processor, and an ECU memory, and
wherein the control device processor is configured to
control the display so that a predetermined output is provided until the moving body fault diagnosis device transmits the information about the progress to the update history management device.

2. The program update management system according to claim 1, wherein
the writing progress information includes writing completion information indicating that the writing of the update program into each of the plurality of individual ECUs has been completed.

3. The program update management system according to claim 1, wherein
the writing progress information includes activation information indicating that the written update program has been made available to the moving body.

4. The program update management system according to claim 1, wherein
the fault diagnosis device processor is configured to
acquire completion notification information indicating that the update based on the update program has been completed, the update program being acquired from the moving body fault diagnosis device, and furthermore information about the completion has been reported to the update history management device, and
wherein the control device processor is configured to
stop the predetermined output based on the completion notification information.

5. The program update management system according to claim 1, wherein
the moving body includes no communication device configured to perform cellular communication.

6. The program update management system according to claim 1, wherein
the moving body control device and the moving body fault diagnosis device are connected to each other through wired communication means, and
the wired communication means is used to:
acquire the update program;
write the update program; and
transmit the writing progress information to the update history management device.

7. The program update management system according to claim 1, wherein
when a first update history which is an update history of the program to be executed by the control device processor matches a predetermined program configuration and it is determined that the control device processor is providing the predetermined output, the moving body fault diagnosis device instructs the control device processor to stop the predetermined output.

8. A moving body fault diagnosis device that includes a fault diagnosis device processor and updates and manages a program for controlling a moving body having a display configured to output information,
wherein the fault diagnosis device processor is configured to:
write an update program of the program into an ECU for controlling the moving body;
transmit information about progress of the writing to an update history management device that manages an update history of the program; and
write a control signal for controlling so that a control device processor of a moving body control device provides a predetermined output until the information about the progress is transmitted to the update history management device.

9. A program update management method that updates and manages a program for controlling a moving body having a display configured to output information, the method comprising:
a writing step of writing an update program of the program into an ECU that performs control of the moving body;
a communication control step of transmitting writing progress information about writing progress of the writing step to an update history management device that manages an update history of the program; and
an output control step of controlling an output so that a predetermined output is provided until the information about the progress is transmitted to the update history management device.
